(19) United States
(12) Patent Application Publication
(10) Pub. No.: US 2007/0138799 A1
(43) Pub. Date: Jun. 21, 2007

(54) Bedspring door

(75) Inventor: David A. Johnson, Minneapolis, MN (US)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: David A. Johnson, Minneapolis, MN (US)

(21) Appl. No.: 11/637,599

(22) Filed: Dec. 12, 2006

Related U.S. Application Data
(60) Provisional application No. 60/749,506, filed on Dec. 12, 2005.

(51) Int. Cl. E05C 7/00

(52) U.S. Cl. 292/50

(57) ABSTRACT

The present invention recycles a bedspring into a door, with relatively few, and relatively inexpensive, modifications to the bedspring.

### BACKGROUND

Bedsprings for twin beds (also referred to as single beds) are often formed of a single layer of very strong, and resilient, material, such as wire, flat metal, expanded metal, or another type of metal formed into a mesh that is suspended between a supporting frame. The supporting frame is often formed in a wide variety of different ways, such as using angle irons, etc.

In any case, such bedsprings are often very strong, in that they must support the weight of at least one grown person, for many years, without fatiguing.

### SUMMARY

The present invention recycles a bedspring into a door, with relatively few, and relatively inexpensive, modifications to the bedspring.

### BRIEF DESCRIPTION OF THE DRAWINGS

FIG. 1 is a view of a bedspring, recycled into a door.

FIG. 2 shows a portion of the door shown in FIG. 1, with a different lock configuration.

FIG. 3 shows a portion of the door shown in FIG. 1, with yet another locking configuration.

FIG. 4 is a method of recycling a bedspring into a door.

### DETAILED DESCRIPTION OF ILLUSTRATIVE EMBODIMENTS

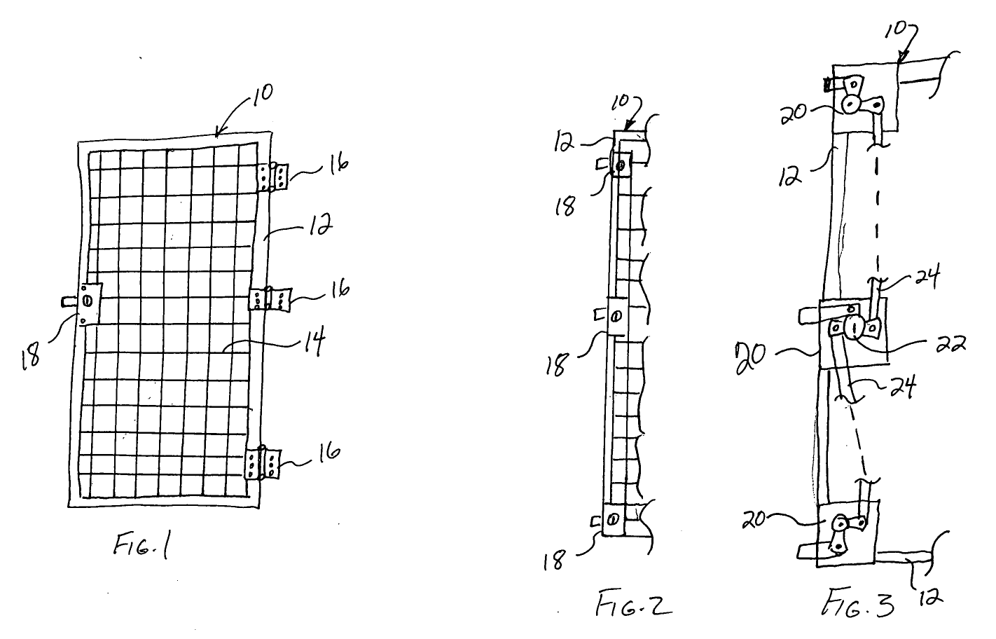

FIG. 1 illustrates a door 10 that is formed of a recycled bedspring. The bedspring includes a frame structure 12 that can be a channel, bent metal, metal or plastic tube or any other desired structure. Door 10 also includes grate 14 that is formed of a plurality of metal or plastic or other strong, resilient cross members. The cross members are illustratively welded to, or otherwise attached to, frame structure 12. The material comprising frame structure 12 and grate 14 can be any desired material. Also, the two can be different materials. For instance, frame structure 12 can be a relatively ridged structural metal material, or other material, while grate 14 can be a relatively resilient spring-type metal, or other strong material. In one embodiment, frame structure 12 and grate 14 are simply composed of a bedspring. The bedspring can be from a bed that is any size such as, single, double, queen or king, depending on the opening of the door.

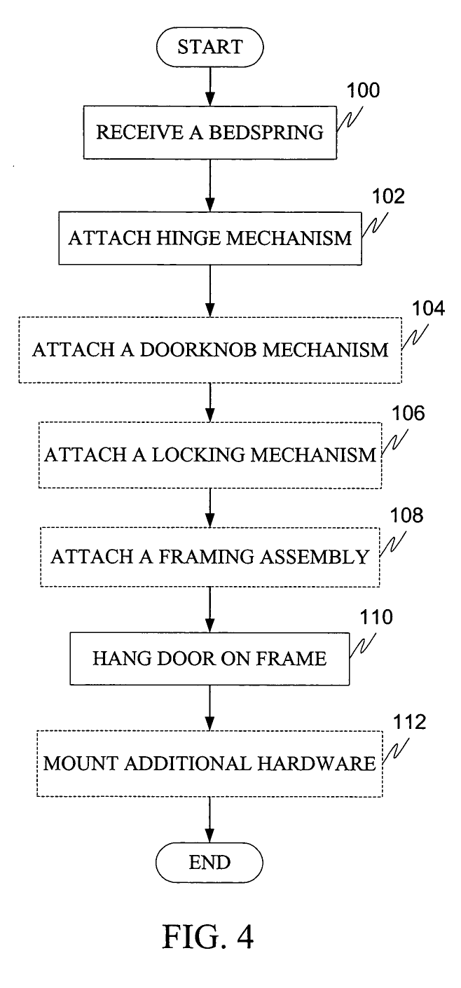

FIG. 4 is a flow diagram illustrating one way of recycling a bedspring into a door. Those blocks shown in phantom are optional. The bedspring is first obtained, as indicated by block 100 in FIG. 4. In order to recycle the bedspring into door 10, a plurality of hinges 16 are illustratively attached to one side of frame structure 12. This is indicated by block 102 in FIG. 4. Hinges 16 can illustratively be attached to the side of frame structure 12 by drilling holes into the frame structure and fastening hinges 16 to the frame structure using screws or nuts and bolts in conjunction with the holes. One or more hinges 16 can be used, and they can be of various types, such as those shown, strap hinges, etc.

Similarly, a doorknob and lock assembly 18 is illustratively attached to the bed frame. The lock 18 is also illustratively welded to, or bolted or screwed to, frame structure 12 of the bed frame, and can also be attached to the cross members of grate 14, as desired. The lock assembly 18 is illustratively a deadbolt lock, but can be any other desired lock as well. Also, a doorknob can be included, if desired, either with, or separate from, lock assembly 18. Attaching the doorknob and lock is indicated by blocks 104 and 106 in FIG. 4.

It will also be noted, of course, that the bed frame can be recycled into door 10 by attaching a pneumatic cylinder, or other type of spring or cylinder assembly to slow the door, or provide resistance to opening the door, or to provide a closing force acting on the door. Such pneumatic cylinders or springs are commonly found on doors and are conventionally known. However, attaching them to a bed frame is not known. They can be attached using screws, welding, or any other desired attachment mechanism.

If the opening of the door is too large for the bedspring door, additional framing material can be attached to the structure defining the opening for the door, such that the door can then be mounted securely and have a desired fit. Mounting the frame assembly and hanging the door are illustrated by blocks 108 and 110 in FIG. 4, respectively.

Finally, additional hardware, such as a storm window or screen (described below) or other hardware (such as a knocker) etc., can be mounted on the bedspring. This is indicated by block 112 in FIG. 4.

FIG. 2 shows a portion of door 10 in which a plurality of locks 18 are provided. In the embodiment shown, locks 18 are not only provided in the central position shown in FIG. 1, but are also illustratively provided near the top and bottom of the frame structure 12 of door 10. Each of the locks 18, in FIG. 2, is individually lockable, using a key, or other similar mechanism.

FIG. 3 shows that a plurality of locks can be provided on the frame structure 12 of door 10. In FIG. 3, three locking assemblies 20 are provided. Again, as shown in FIG. 2, one of the locking assemblies 20 is provided near the central portion of the side of frame structure 12 on which the locks are mounted, while the other two locking assemblies 20 are provided near the top and bottom of frame structure 12. In the embodiment shown in FIG. 3, a single key lock 22 is provided that actuates the bolts for locking and unlocking the locks corresponding to each of locking assemblies 20. For instance, as the key lock 22 is turned counterclockwise, bars 24 act on the locking assemblies to rotate the bolts in a counterclockwise direction to engage corresponding locks and lock the door. As the key lock 22 is turned in the clockwise direction, the locks 22 act on the locking assemblies to move the bolts in order to disengage the locks, and unlock the door. Of course, any other type of multiple lock assembly can be used as well.

It will also be noted that door 10 can be fitted with weather stripping, or other material around its perimeter to provide a tight fitting, or snug fitting, engagement with the doorframe. Further, a finer mesh screen can be disposed over the top of grate 14, in order to provide a screen door. The finer mesh screen can be attached by welding, or it can be detachably connected to grate 14 using screws, fittings, hook and loop fabric, or any other type of releasable attachment mechanism.

It should also be noted that the frame structure 12 can be modified to include receiving members that receive a storm window for covering grate 14, such as in the winter months. The receiving members, can, for instance, simply be small portions of channel or brackets that can be screwed onto frame structure 12 in order to hold the window adjacent grate 14. They can then be removed during the summer months, when the window is not attached, and when the fine mesh screen is attached.

Although the present invention has been described with reference to preferred embodiments, workers skilled in the art will recognize that changes may be made in form and detail without departing from the spirit and scope of the invention.

What is claimed is:

1. A bedspring door.

2. The bedspring door of claim 1 comprising:
a grate, and a frame attached to an outer periphery of the grate.

3. The bedspring door of claim 2 and further comprising:
a hinge mechanism attached to the frame.

4. The bedspring door of claim 2 and further comprising:
a locking mechanism attached to the frame.

5. The bedspring door of claim 4 wherein the locking mechanism comprises:
a plurality of interconnected locks.

6. The bedspring door of claim 4 wherein the locking mechanism comprises:
a deadbolt lock.

7. A method of recycling a bedspring into a door, comprising:
attaching a door hinge assembly to the bedspring.

8. The method of claim 7 and further comprising:
attaching a door locking mechanism to the bedspring.

9. The method of claim 8 and further comprising:
attaching a doorknob to the bedspring.

10. The method of claim 7 and further comprising:
mounting a framing assembly to a door opening.

11. The method of claim 10 and further comprising:
hanging the bedspring on the framing assembly with the hinge assembly.

12. The method of claim 8 wherein attaching a locking mechanism comprises:
attaching a plurality of lockably interconnected locks to the bedspring.

13. The method of claim 7 and further comprising:
mounting a screen to the bedspring.

14. The method of claim 7 and further comprising:
mounting a storm window to the bedspring.
